(19) United States
(12) Patent Application Publication
(10) Pub. No.: US 2014/0089266 A1
(43) Pub. Date: Mar. 27, 2014

(54) INFORMATION PROCESSING SYSTEM

(71) Applicants: Toshiba Solutions Corporation, (US); KABUSHIKI KAISHA TOSHIBA, Tokyo (JP)

(72) Inventors: Yasuomi Une, Kanagawa (JP); Junichi Yamamoto, Tokyo (JP); Masataka Yamada, Tokyo (JP); Shinko Riku, Tokyo (JP); Seiichiro Tanaka, Saitama (JP)

(73) Assignees: TOSHIBA SOLUTIONS CORPORATION, Tokyo (JP); KABUSHIKI KAISHA TOSHIBA, Tokyo (JP)

(21) Appl. No.: 13/846,045

(22) Filed: Mar. 18, 2013

Related U.S. Application Data
(63) Continuation of application No. PCT/JP2012/074582, filed on Sep. 25, 2012.

(51) Int. Cl. G06F 11/14

(52) U.S. Cl. CPC G06F 11/1469
USPC 707/679

(57) ABSTRACT

According to an embodiment, an information processing system includes a storage unit to store install information of a user system implemented by a virtual machine, backup data of data of the user system, and cache data; a virtual machine creating unit; a restoration unit to restore the data of the user system using the backup data; a cache controller to copy a part of the data of the user system to the cache data and, in the event of the fault of the user system, partially recover the user system by restoring a part of the data of the user system from the cache data; and an access standby unit to, after the partial recovery, prevent an access to the data of the user system, data integrity of which is not guaranteed, until the user system is fully recovered by using the backup data.

### CROSS-REFERENCE TO RELATED APPLICATIONS

This application is a continuation of PCT international application Ser. No. PCT/JP2012/074582 filed on Sep. 25, 2012 which designates the United States, incorporated herein by reference.

### FIELD

Embodiments described herein relate generally to an information processing system.

### BACKGROUND

As one of operation types of an information processing system, there is known a multi-tenant system in which a plurality of companies or the like uses one system environment. Furthermore, there is known a Platform as a Service (PaaS) that provides a platform necessary for operating a tenant system, such as a business system or the like, by using a virtual machine, without preparing hardware for each user.

Furthermore, there is known technique that, when a fault occurs in an information processing system, recovers the information processing system from the fault. As one example of fault recovery technique, there is known technique that reproduces a state of an application of an information processing system at a specific time point, based on a snapshot that is backup data of the information processing system at the specific time point.

However, in the case of recovering an information processing system by using a snapshot, when an amount of data is large, there is a problem that the information processing system is not available for use for a long time because a time for recovery is long.

### BRIEF DESCRIPTION OF THE DRAWINGS

FIG. 1 is a diagram for describing an example of a configuration of an information processing system;

FIG. 2 is a diagram for describing an example of a configuration of an information processing system of a first embodiment;

FIG. 3 is a diagram for describing an example of data immediately after partial recovery of an information processing system of the first embodiment;

FIG. 4 is a diagram for describing an example of data immediately after full recovery of the information processing system of the first embodiment;

FIG. 5 is a flow chart for describing an example of a method for determining access prevention at the time of partial recovery of the information processing system of the first embodiment;

FIG. 6 is a diagram for describing an example of data immediately after partial recovery of an information processing system of a second embodiment;

FIG. 7 is a diagram for describing an example of data immediately after full recovery of the information processing system of the second embodiment;

FIG. 8 is a flow chart for describing an example of a method for determining access prevention at the time of partial recovery of the information processing system of the second embodiment;

FIG. 9 is a diagram for describing an example of data immediately after partial recovery of an information processing system of a third embodiment;

FIG. 10 is a diagram for describing an example of data immediately after full recovery of the information processing system of the third embodiment;

FIG. 11 is a flow chart for describing an example of a method for determining access prevention at the time of partial recovery of the information processing system of the third embodiment;

FIG. 12 is a diagram for describing a first modification of the configurations of the information processing systems of the first, second and third embodiments;

FIG. 13 is a diagram for describing a second modification of the configurations of the information processing systems of the first, second and third embodiments;

FIG. 14 is a diagram for describing a third modification of the configurations of the information processing systems of the first, second and third embodiments; and

FIG. 15 is a diagram illustrating an example of a hardware configuration of the information processing apparatus on which the fault recovery systems and the virtual machines of the first, second and third embodiments operate.

### DETAILED DESCRIPTION

According to an embodiment, an information processing system includes a storage unit, a virtual machine creating unit, a restoration unit, a cache controller, and an access standby unit. The storage unit is configured to store therein install information of a user system implemented by a virtual machine, backup data of data of the user system, and cache data representing a part of the data of the user system. The virtual machine creating unit is configured to create the virtual machine using the install information. The restoration unit is configured to restore the data of the user system using the backup data. The cache controller is configured to copy a part of the data of the user system to the cache data and, in the event of the fault of the user system, partially recover the user system by restoring a part of the data of the user system from the cache data. The access standby unit is configured to, after the partial recovery, prevent an access to the data of the user system, data integrity of which is not guaranteed, until the user system is fully recovered by restoring the data of the user system, which is not restored using the cache data, by using the backup data.

Various embodiments will be described with reference to the accompanying drawings.

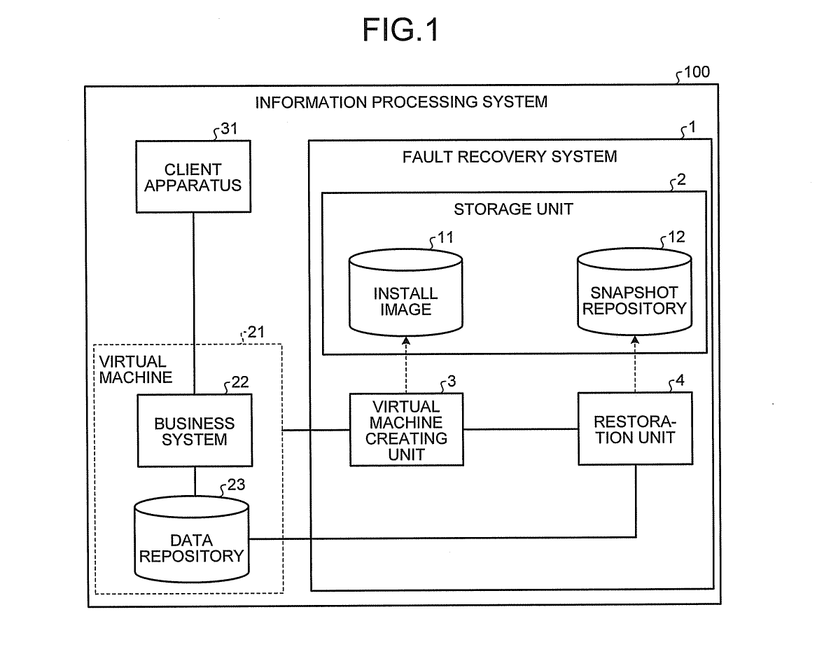

FIG. 1 is a diagram for describing an example of a configuration of an information processing system 100. The information processing system 100 includes a fault recovery system 1, a virtual machine 21, and a client apparatus 31. The virtual machine 21 includes a business system 22 and a data repository 23. The business system 22 is used by a user's access from the client apparatus 31. The data repository 23 stores data used in the business system 22 (hereinafter, referred to as “business data”).

When a fault occurs in the virtual machine 21, the fault recovery system 1 recovers the user business system 22 and the data repository 23 by newly creating the virtual machine 21. The fault recovery system 1 includes a storage unit 2, a virtual machine creating unit 3, and a restoration unit 4.

The storage unit 2 stores therein an install image 11 and a snapshot repository 12. The install image 11 is an image file that stores therein an initial state of a user tenant system implemented by the virtual machine 21. Alternatively, the install image 11 may be install information of a format other than an image file format. The snapshot repository 12 stores therein a snapshot of the business data of the data repository 23. The snapshot is backup data of the business data that is periodically obtained.

When a fault occurs in the virtual machine 21, the virtual machine creating unit 3 newly creates the virtual machine 21 of an initial state by using the install image 11. The restoration unit 4 recovers the data repository 23 using the snapshot by using the snapshot repository 12.

The information processing system 100 enables the tenant system of the initial state to be reproduced on the virtual machine 21 from the install image 11, and data for each tenant system is restored from the snapshot repository 12. By implementing the user tenant system by the virtual machine 21, the fault recovery of the tenant system is enabled without preparing hardware of a standby system for each user.

### First Embodiment

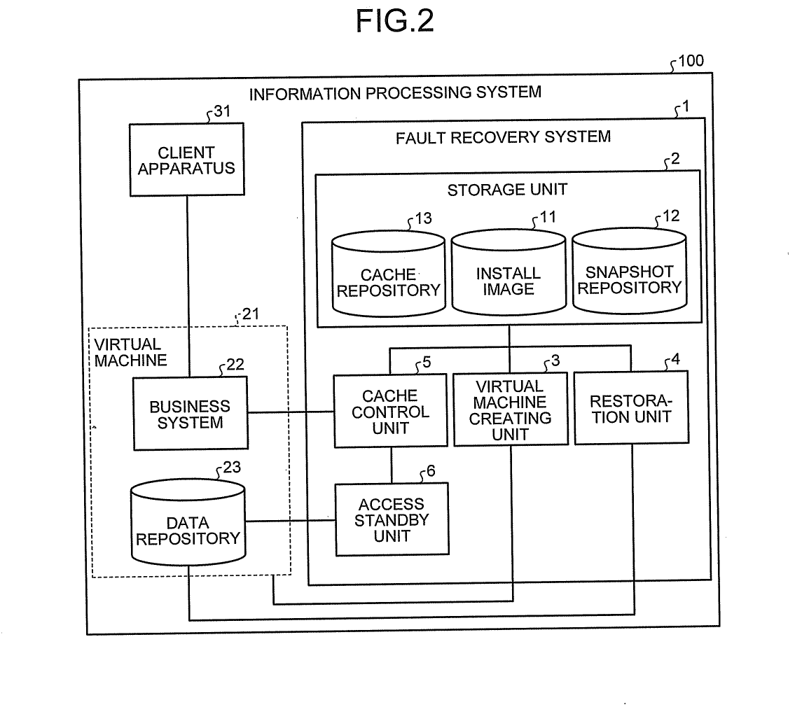

FIG. 2 is a diagram for describing an example of a configuration of an information processing system 100 of a first embodiment. The information processing system 100 includes a fault recovery system 1, a virtual machine 21, and a client apparatus 31. First, a user tenant system, which is subjected to fault recovery by the fault recovery system 1, will be described.

The user tenant system is implemented by the virtual machine 21. One or more virtual machines 21 are implemented on hardware, such as an information processing apparatus or the like, as software. The virtual machine 21 operates as if implemented as dedicated hardware, with respect to other apparatus or software, under the control of the software implementing the virtual machine 21.

The virtual machine 21 includes a business system 22 and a data repository 23. The business system 22 is used by a user accessing from the client apparatus 31. The data repository 23 stores therein business data. The business system 22 performs registration, update, reference, and deletion of the business data according to the operation of the client apparatus 31.

The user tenant system (the business system 22 and the data repository 23), which is subjected to fault recovery by the fault recovery system 1, is not limited to systems used for business. Instead of the tenant system, it may be any user system. That is, it may be any system (software) operating on the virtual machine 21.

In the present embodiment, a type of the data repository 23 is assumed as a Key Value Store (KVS). The KVS is a storage type that stores data and a key identifying the corresponding data in pair.

The fault recovery system 1 of the present embodiment includes a storage unit 2, a virtual machine creating unit 3, a restoration unit 4, a cache control unit 5, and an access standby unit 6.

The storage unit 2 stores therein an install image 11, a snapshot repository 12, and a cache repository 13. The install image 11 is data of an initial state of the user tenant system implemented by the virtual machine 21. The snapshot repository 12 stores therein a snapshot of the business data of the data repository 23. The cache repository 13 stores therein cache data representing a part of the business data.

When a fault occurs in the virtual machine 21, the virtual machine creating unit 3 newly creates the virtual machine 21 of an initial state by using the install image 11.

The restoration unit 4 restores the data repository 23 using the snapshot by using the snapshot repository 12. The restoration unit 4 does not overwrite data restored by the cache control unit 5 from the cache data of the cache repository 13 with the corresponding data included in the snapshot.

The cache control unit 5 and the access standby unit 6 are present between the business system 22 and the data repository 23 and operate as proxy. That is, when accessing the business data of the data repository 23, the business system 22 performs the access through the cache control unit 5 and the access standby unit 6.

The cache control unit 5 copies the business data accessed from the business system 22 to the cache repository 13. The cache control unit 5 deletes the cache data when the snapshot is stored in the snapshot repository 12. This prevents an increase in the capacity of the cache data. The cache control unit 5 may delete only a part of the cache data, according to elapsed days from the registration of data, data access frequency, or the like.

In the event of the fault of the business system 22, the cache control unit 5 partially recovers the business system 22 using the business data restored from the cache data of the cache repository 13. That is, the fault recovery system 1 recovers the business system 22 by restoring a part of the business data from the cache data, without using the snapshot of the snapshot repository 12.

The cache data necessary for partially recovering the user tenant system (virtual machine 21) is different for each tenant system. As one example of a method that acquires cache data stored in the cache repository 13, there is a method that acquires all accessed business data after the snapshot is generated.

The access standby unit 6 does nothing when the virtual machine 21 is in a normal state. After partial recovery of the business data performed by the cache control unit 5 and before full recovery of the business data performed by the restoration unit 4 (hereinafter, referred to as “partial recovery”), the access standby unit 6 prevents the access to the business data, integrity of which is not guaranteed. That is, the access standby unit 6 holds a request for access to the business data, integrity of which is not guaranteed, in a buffer or the like. When the virtual machine 21 is returned to the normal state, the access standby unit 6 releases the access request, which has been held in the buffer, by means of a First In First Out (FIFO) scheme or the like. A method for determining access prevention by the access standby unit 6 will be described in detail below.

After the full restoration of the business data by the restoration unit 4 (hereinafter, referred to as “full recovery”), the access standby unit 6 recognizes that the virtual machine 21 has been returned to the normal state.

Meanwhile, the virtual machine creating unit 3, the restoration unit 4, the cache control unit 5, and the access standby unit 6 of the present embodiment may be implemented by software, or may be implemented by hardware such as Integrated Circuit (IC) or the like. Alternatively, they may be implemented by both of software and hardware.

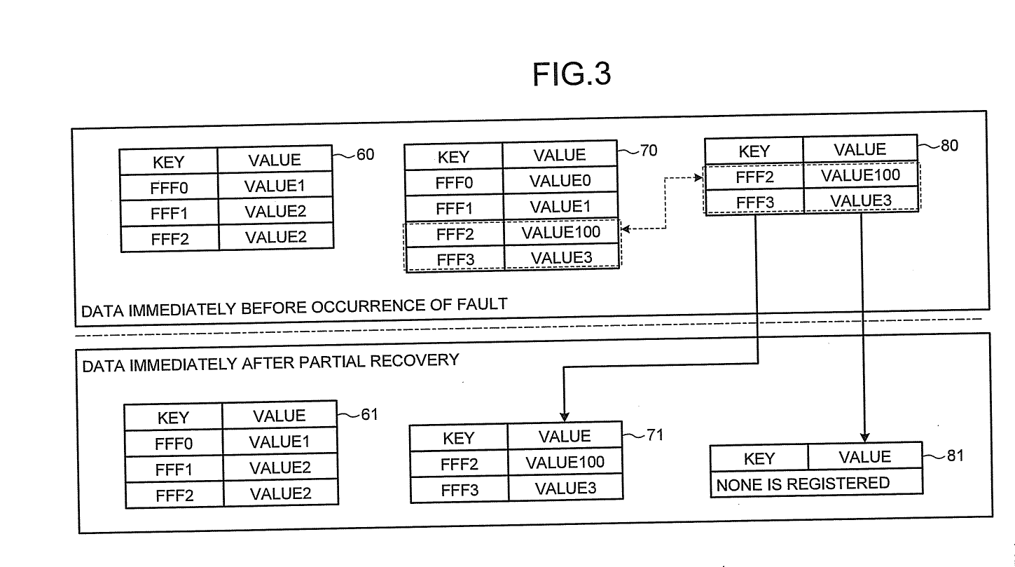

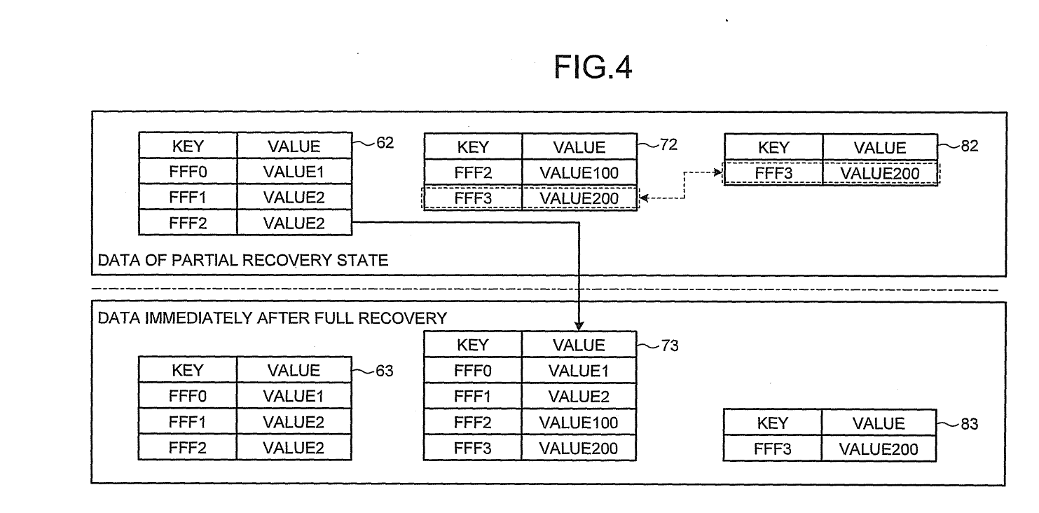

Next, the data stored in the snapshot repository 12, the cache repository 13, and the data repository 23 of the present embodiment between the occurrence of the fault and the full recovery will be described with reference to FIGS. 3 and 4.

FIG. 3 is a diagram for describing an example of data immediately after the partial recovery of the information processing system 100 of the first embodiment. Data 60 is data of the snapshot repository 12 immediately before the occurrence of the fault. Data 70 is data of the data repository 23 immediately before the occurrence of the fault. Data 80 is data of the cache repository 13 immediately before the occurrence of the fault.

In the example of FIG. 3 illustrating the data immediately before the occurrence of the fault, data of (KEY, VALUE)=(FFF2, VALUE100) of the data repository 23 is updated after the acquisition of the snapshot (VALUE of KEY=FFF2 is updated from VALUE2 to VALUE100). Data of (KEY, VALUE)=(FFF3, VALUE3) is registered in the data repository 23 after the acquisition of the snapshot.

Therefore, data 80 ((KEY, VALUE)=(FFF2, VALUE100) and (FFF3, VALUE3)) are stored in the cache repository 13. That is, the cache repository 13 of the present embodiment stores therein the data of the data repository 23 that has been accessed after the acquisition of the snapshot.

Data 61 is data of the snapshot repository 12 immediately after the partial recovery. Data 71 is data of the data repository 23 immediately after the partial recovery. Data 81 is data of the cache repository 13 immediately after the partial recovery.

In the example of FIG. 3 illustrating the data immediately after the partial recovery, data 71 ((KEY, VALUE)=(FFF2, VALUE100) and (FFF3, VALUE3)) of the data repository 23 are recovered from the data 80 of the cache repository 13 immediately before the occurrence of the fault. After the partial recovery of the data repository 23, the data 80 of the cache repository 13 is deleted by the cache control unit 5.

FIG. 4 is a diagram for describing an example of data immediately after the full recovery of the information processing system 100 of the first embodiment. Data 62 is data of the snapshot repository 12 of the partial recovery state. Data 72 is data of the data repository 23 of the partial recovery state. Data 82 is data of the cache repository 13 of the partial recovery state.

In the example of FIG. 4 illustrating the data of the partial recovery state, data of (KEY, VALUE)=(FFF3, VALUE200) of the data repository 23 is updated in the partial recovery state (VALUE is updated from VALUE3 to VALUE200). Therefore, data of (KEY, VALUE)=(FFF3, VALUE200) is registered in the cache repository 13. That is, the cache repository 13 of the present embodiment stores therein the data of the data repository 23 that is accessed in the partial recovery state.

Data 63 is data of the snapshot repository 12 immediately after the full recovery. Data 73 is data of the data repository 23 immediately after the full recovery. Data 83 is data of the cache repository 13 immediately after the full recovery.

In the example of FIG. 4 illustrating the data immediately after the full recovery, (KEY, VALUE)=(FFF0, VALUE1) and (FFF1, VALUE2) among the data 73 of the data repository 23 is restored using the data 62 of the snapshot repository 12. Since (KEY, VALUE)=(FFF2, VALUE2) is already restored from the data 80 of the cache repository 13 immediately before the occurrence of the fault (FIG. 3), the restoration unit 4 does not overwrite VALUE of KEY=FFF2 with VALUE2.

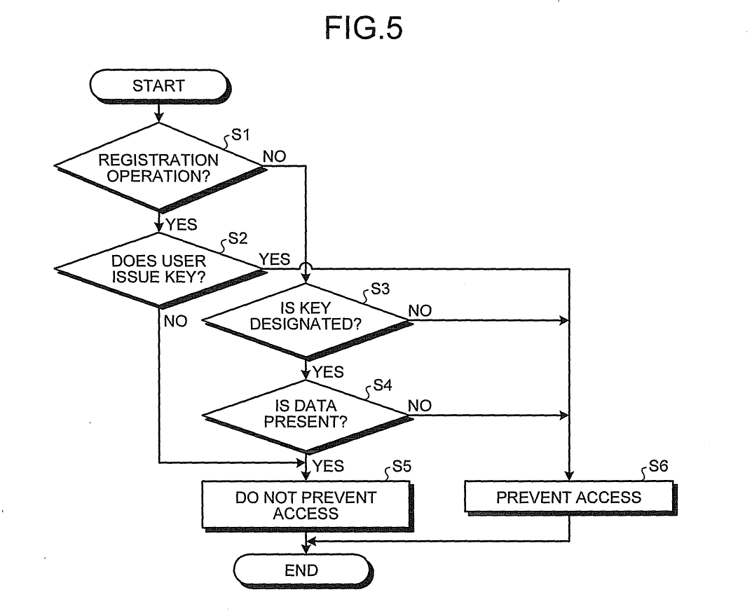

Next, the method for determining the access prevention in the partial recovery state according to the present embodiment will be described. FIG. 5 is a flow chart for describing an example of the method for determining the access prevention at the time of the partial recovery of the information processing system 100 of the first embodiment.

The access standby unit 6 determines whether the access to the data repository 23 is for registration operation (step S1). When the access is for the registration operation (Yes in step S1), the process proceeds to step S2. When the access is not for the registration operation (No in step S1), the process proceeds to step S3.

The access standby unit 6 determines whether the user issues a key (step S2). When the user issues the key (Yes in step S2), the access standby unit 6 prevents the access to the data repository 23 (step S6). In this way, it is possible to prevent the loss of data integrity caused by registration of unexpected data of the business system 22 into the data repository 23 by the user.

When the user does not issue the key (No in step S2), the access standby unit 6 does not prevent the access to the data repository 23 (step S5). The reason is that since the business system 22 issues an expected appropriate key, the business system 22 determines that data integrity is maintained even when new data is registered in the data repository 23 of the partial recovery state.

The access standby unit 6 determines whether the access to the data repository 23 is for operation to which the key is designated (reference operation, updating operation, or deletion operation) (step S3). When the key is designated (Yes in step S3), the process proceeds to step S4. When the key is not designated (No in step S3), the access standby unit 6 prevents the access to the data repository 23 (step S6). The reason for determining the permission or prohibition of the access based on whether the key is designated is because whether the key is designated is one guideline on whether data integrity after the corresponding operation can be guaranteed.

The access standby unit 6 determines whether data that is an operation target is present in the data repository 23 (step S4). When the data that is an operation target is present (Yes in step S4), the access standby unit 6 does not prevent the access to the data repository 23 (step S5). When the data that is an operation target is not present (No in step S4), the access standby unit 6 prevents the access to the data repository 23 (step S6).

In the above-described method for determining the access prevention, the operations for which an access to the KVS-type data repository 23 is not prevented in the partial recovery state are the following cases (1) to (4).

(1) The data registered in the KVS is referenced by designating the key. (2) The data registered in the KVS is updated by designating the key. (3) The data registered in the KVS is deleted by designating the key. (4) The data, for which the appropriate key is issued by the business system 22, is registered.

According to the information processing system 100 of the present embodiment, even when the fault occurs in the virtual machine 21, the sustainability of the operation on the data of the KVS-type data repository 23 having recently been used by the user is guaranteed by the rapid partial recovery of the user tenant system and the above-described method for determining the access prevention.

Furthermore, according to the information processing system 100 of the present embodiment, the user tenant system, even in the partial recovery state, can complete the operation in which the data integrity of the KVS-type data repository 23 is maintained, without causing the operation to wait.

Alternatively, in a case where the access standby unit 6 prevents the access to the data repository 23, the access standby unit 6 may calculate a time necessary for fully recovering the data repository 23, based on an amount of data to be recovered, or the like, and determine whether the calculated time is elapsed.

Furthermore, in a case where the access standby unit 6 prevents the access until the full recovery, when it is expected to take a long time for the full recovery, the access standby unit 6 may immediately return an error to the user client apparatus 31. That is, the access standby unit 6 calculates the time taken for the full recovery, based on an amount of business data to be restored, and, when the calculated time exceeds a predetermined threshold value, the access standby unit 6 may return an error, without preventing the access to the business data.

### Second Embodiment

In the information processing system 100 of the first embodiment, the data repository 23 of the virtual machine 21 is assumed as the KVS. However, the storage type of the data repository 23 is not limited to the KVS. In the present embodiment, a case where the data repository 23 of the virtual machine 21 is a Relational Database (RDB) will be described. Generally, the RDB has more dependency or relevancy between data than the KVS. In the present embodiment, such a case will be described.

The configuration of the information processing system 100 of the present embodiment is identical to that of the information processing system 100 of the first embodiment of FIG. 2. In the description of the configuration of the information processing system 100 of the present embodiment, parts identical to the information processing system 100 of the first embodiment will be omitted. Furthermore, the user tenant system to be recovered by the information processing system 100 of the present embodiment is identical, except that the storage type of the data repository 23 is not the KVS but the RDB.

As in the first embodiment, the cache control unit 5 of the present embodiment functions as a proxy that relays the access from the business system 22 to the data repository 23. Furthermore, the cache control unit 5 copies data, which is registered, updated and referenced from the business system 22 to the data repository 23, to the cache repository 13.

The cache control unit 5 acquires all columns, with respect to a query string accessing only a specific column of a target record as well as the specific column, by reference and updating, or the like, and registers the acquired columns in the cache repository 13.

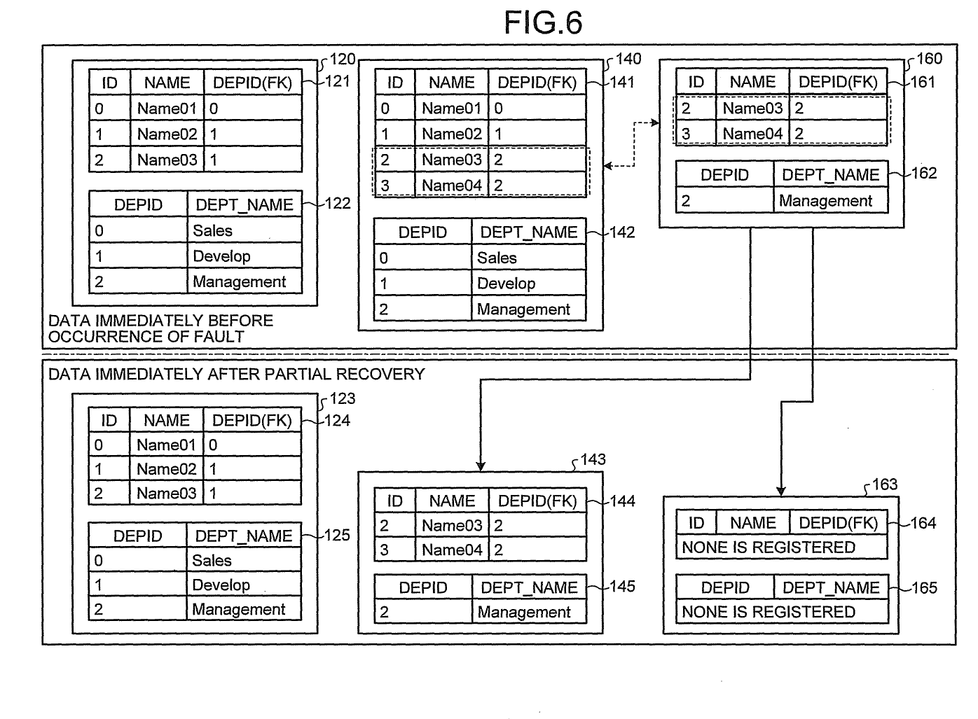

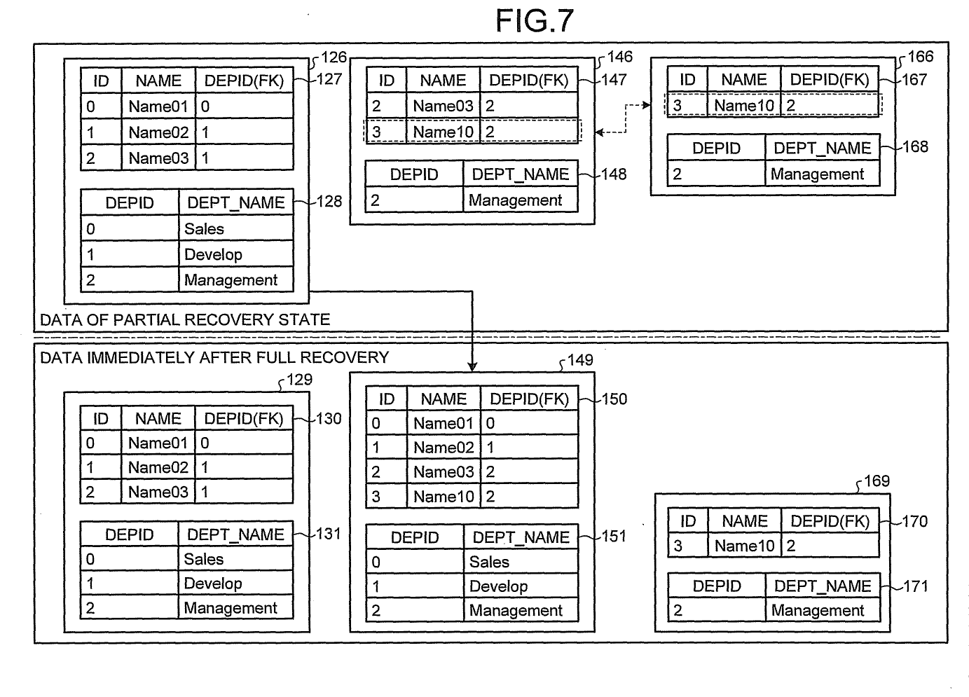

Data of the snapshot repository 12, the cache repository 13, and the data repository 23 of the present embodiment between the occurrence of the fault and the full recovery will be described with reference to FIGS. 6 and 7.

In the examples of FIGS. 6 and 7, a case where the data repository 23 stores therein a employee table including ID, NAME, and DEPID columns, and a department table including DEPID and DEPT_NAME columns will be described. The DEPID of the employee table is a primary key in the department table. That is, the DEPID of the employee table is an external key.

FIG. 6 is a diagram for describing an example of data immediately after the partial recovery of the information processing system 100 of the second embodiment. Data 120 is data of the snapshot repository 12 immediately before the occurrence of the fault. The data 120 includes data 121 and data 122. The data 121 is data of the employee table immediately before the occurrence of the fault. The data 122 is data of the department table immediately before the occurrence of the fault.

Data 140 is data of the data repository 23 immediately before the occurrence of the fault. The data 140 includes data 141 and data 142. The data 141 is data of the employee table immediately before the occurrence of the fault. The data 142 is data of the department table immediately before the occurrence of the fault.

Data 160 is data of the cache repository 13 immediately before the occurrence of the fault. The data 160 includes data 161 and data 162. The data 161 is data of the employee table immediately before the occurrence of the fault. The data 162 is data of the department table immediately before the occurrence of the fault.

In the example of FIG. 6 illustrating the data immediately before the occurrence of the fault, data of (ID, NAME, DEPID)=(2, Name03, 2) of the data repository 23 is updated after the acquisition of the snapshot (DEPID is updated from 1 to 2). Data of (ID, NAME, DEPID)=(3, Name04, 2) is registered in the data repository 23 after the acquisition of the snapshot.

Therefore, the data 161 ((ID, NAME, DEPID)=(2, Name03, 2) and (3, Name04, 2)) are stored in the cache repository 13. The data 162 ((DEPID, DEPT_NAME)=(2, Management)) of the department table related to the external key DEPID=2 of the employee table is also stored. That is, the cache repository 13 of the present embodiment stores the data of the data repository 23 that has been accessed after the acquisition of the snapshot, and data related by the setting of the external key or the like to the data.

Data 123 is data of the snapshot repository 12 immediately after the partial recovery. The data 123 includes data 124 and data 125. The data 124 is data of the employee table immediately after the partial recovery. The data 125 is data of the department table immediately after the partial recovery.

Data 143 is data of the data repository 23 immediately after the partial recovery. The data 143 includes data 144 and data 145. The data 144 is data of the employee table immediately after the partial recovery. The data 145 is data of the department table immediately after the partial recovery.

Data 163 is data of the cache repository 13 immediately after the partial recovery. The data 163 includes data 164 and data 165. The data 164 is data of the employee table immediately after the partial recovery. The data 165 is data of the department table immediately after the partial recovery.

In the example of FIG. 6 illustrating the data immediately after the partial recovery, data 144 ((ID, NAME, DEPID)=(2, Name03, 2) and (3, Name04, 2)) of the data repository 23 are recovered from the data 161 of the cache repository 13 immediately before the occurrence of the fault. Data 145 ((DEPID, DEPT_NAME)=(2, Management)) of the data repository 23 is recovered from the data 162 of the cache repository 13 immediately before the occurrence of the fault. After the partial recovery of the data repository 23, the data 161 and the data 162 of the cache repository 13 are deleted by the cache control unit 5.

FIG. 7 is a diagram for describing an example of data immediately after the full recovery of the information processing system 100 of the second embodiment. Data 126 is data of the snapshot repository 12 of the partial recovery state. The data 126 includes data 127 and data 128. The data 127 is data of the employee table of the partial recovery state. The data 128 is data of the department table of the partial recovery state.

Data 146 is data of the data repository 23 of the partial recovery state. The data 146 includes data 147 and data 148. The data 147 is data of the employee table of the partial recovery state. The data 148 is data of the department table of the partial recovery state.

Data 166 is data of the cache repository 13 of the partial recovery state. The data 166 includes data 167 and data 168. The data 167 is data of the employee table of the partial recovery state. The data 168 is data of the department table of the partial recovery state.

In the example of FIG. 7 illustrating the data of the partial recovery state, data of (ID, NAME, DEPID)=(3, Name10, 2) of the data repository 23 is updated in the partial recovery state (NAME is updated from Name04 to Name10). Therefore, data of (ID, NAME, DEPID)=(3, Name10, 2) is registered in the cache repository 13. The data 168 ((DEPID, DEPT_NAME)=(2, Management)) of the department table related to the external key DEPID=2 of the employee table is also stored.

That is, the cache repository 13 of the present embodiment stores therein the data of the data repository 23 that has been accessed in the partial recovery state, and data related by the setting of the external key or the like to the data.

Data 129 is data of the snapshot repository 12 immediately after the full recovery. The data 129 includes data 130 and data 131. The data 130 is data of the employee table immediately after the full recovery. The data 131 is data of the department table immediately after the full recovery.

Data 149 is data of the data repository 23 immediately after the full recovery. The data 149 includes data 150 and data 151. The data 150 is data of the employee table immediately after the full recovery. The data 151 is data of the department table immediately after the full recovery.

Data 169 is data of the cache repository 13 immediately after the full recovery. The data 169 includes data 170 and data 171. The data 170 is data of the employee table immediately after the full recovery. The data 171 is data of the department table immediately after the full recovery.

In the example of FIG. 7 illustrating the data immediately after the full recovery, (ID, NAME, DEPID)=(0, Name01, 0) and (1, Name02, 1) among the data 150 of the data repository 23 is restored using the data 127 of the snapshot repository 12. Furthermore, (DEPID, DEPT_NAME)=(0, Sales) and (1, Develop) among the data 151 of the data repository 23 is restored using the data 128 of the snapshot repository 12.

Since (ID, NAME, DEPID)=(2, Name03, 2) is already restored from the data 161 of the cache repository 13 immediately before the occurrence of the fault (FIG. 6), the restoration unit 4 does not overwrite DEPID with 1.

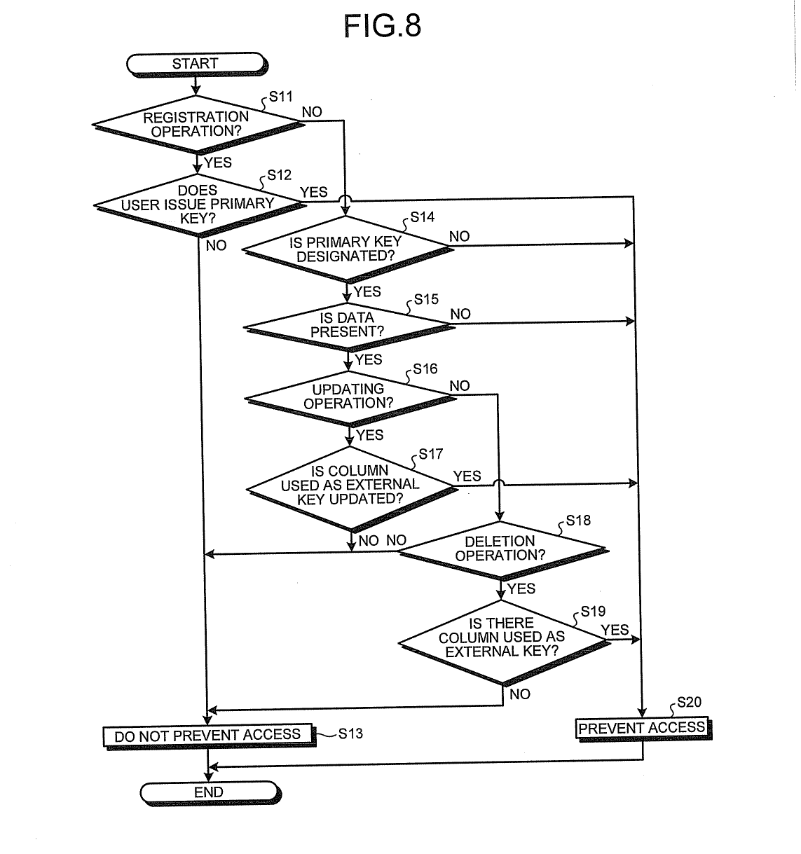

Next, the method for determining the access prevention in the partial recovery state according to the present embodiment will be described. FIG. 8 is a flow chart for describing an example of the method for determining the access prevention at the time of the partial recovery of the information processing system 100 of the second embodiment.

The access standby unit 6 determines whether the access to the data repository 23 is for registration operation (step S11). When the access is for the registration operation (Yes in step S11), the process proceeds to step S12. When the access is not for the registration operation (No in step S11), the process proceeds to step S14.

The access standby unit 6 determines whether the user issues a primary key (step S12). When the user issues the primary key (Yes in step S12), the access standby unit 6 prevents the access to the data repository 23 (step S20). In this way, it is possible to prevent the loss of data integrity caused by registration of unexpected data of the business system 22 into the data repository 23 by the user.

When the user does not issue the primary key (No in step S12), the access standby unit 6 does not prevent the access to the data repository 23 (step S13). The reason is that since an expected appropriate primary key is issued, the business system 22 determines that data integrity is maintained even when new data is registered in the data repository 23 of the partial recovery state.

The access standby unit 6 determines whether the access to the data repository 23 is for operation to which the primary key is designated (reference operation, updating operation, or deletion operation) (step S14). When the primary key is designated (Yes in step S14), the process proceeds to step S15. When the primary key is not designated (No in step S14), the access standby unit 6 prevents the access to the data repository 23 (step S20). The reason for determining the permission or prohibition of the access based on whether the primary key is designated is because whether the primary key is designated is one guideline on whether data integrity after the corresponding operation can be guaranteed.

The access standby unit 6 determines whether data that is an operation target is present in the data repository 23 (step S15). When the data that is an operation target is present (Yes in step S15), the process proceeds to step S16. When the data that is an operation target is not present (No in step S15), the access standby unit 6 prevents the access to the data repository 23 (step S20).

The access standby unit 6 determines whether the access to the data repository 23 is for updating operation (step S16). When the access is for the updating operation (Yes in step S16), the process proceeds to step S17. When the access is not for the updating operation (No in step S16), the process proceeds to step S18.

The access standby unit 6 determines whether a column to be updated is a column used as an external key (step S17). When the column is the column used as the external key (Yes in step S17), the access standby unit 6 prevents the access to the data repository 23 (step S20). When the column is not the column used as the external key (No in step S17), the access standby unit 6 does not prevent the access to the data repository 23 (step S13).

The access standby unit 6 determines whether the access to the data repository 23 is for deletion operation (step S18). When the access is for the deletion operation (Yes in step S18), the process proceeds to step S19. When the access is not for the deletion operation (No in step S18), the access standby unit 6 does not prevent the access to the data repository 23 (step S13).

The access standby unit 6 determines whether the column used as the external key is included in data to be deleted (step S19). When the column used as the external key is included (Yes in step S19), the access standby unit 6 prevents the access to the data repository 23 (step S20). When the column used as the external key is not included (No in step S19), the access standby unit 6 does not prevent the access to the data repository 23 (step S13).

In the above-described method for determining the access prevention, the operations for which an access to the RDB-type data repository 23 is not prevented in the partial recovery state are the following cases (1) to (4).

(1) The data registered in the RDB is referenced by designating the primary key. (2) The column, which is not used as the external key of the data registered in the RDB, is updated by designating the primary key. (3) From the table in which the column used as the external key is not present, the data is deleted by designating the primary key. (4) The data, for which the appropriate primary key is issued by the business system 22, is registered.

According to the information processing system 100 of the present embodiment, even when the fault occurs in the virtual machine 21, the sustainability of the operation on the data of the RDB-type data repository 23 having recently been used by the user is guaranteed by the rapid partial recovery of the virtual machine 21 and the above-described method for determining the access prevention.

Furthermore, according to the information processing system 100 of the present embodiment, the virtual machine 21, even in the partial recovery state, can complete the operation in which the data integrity of the RDB-type data repository 23 is maintained, without causing the operation to wait.

### Third Embodiment

In the information processing systems 100 of the first and second embodiments, the cache control unit 5 registers the data of the data repository 23, which has been accessed after the acquisition of the snapshot, in the cache repository 13. However, the cache repository 13 may previously register predetermined data, without regard to the presence or absence of the access by the user. In this way, the fault recovery system 1 can expand the partial recovery range of the tenant system implemented by the virtual machine 21. In the present embodiment, such a case will be described.

The configuration of the information processing system 100 of the present embodiment is identical to that of the information processing system 100 of the first embodiment of FIG. 2. In the description of the configuration of the information processing system 100 of the present embodiment, parts identical to the information processing system 100 of the first embodiment will be omitted. Furthermore, the user tenant system to be recovered by the information processing system 100 of the present embodiment is described on the assumption that the storage type of the data repository 23 is the RDB. However, the storage type of the data repository 23 of the user tenant system to be recovered is not limited to the RDB.

The cache repository 13 of the present embodiment stores therein cache data representing a part of the business data. The cache repository 13 further stores therein predetermined data as well as the business data accessed from the business system 22. The predetermined data, for example, is data taking on an important role in the business system 22, such as data of a table necessarily referenced for operating the business system 22, or data of a table with high access frequency.

The predetermined data stored in the cache repository 13 may be used as a primary cache of the access from the business system 22 to the data repository 23. In this way, even during the normal operation in which the fault does not occur, there is an effect that the access to the data of the data repository 23 from the business system 22 becomes high-speed.

The predetermined data may be all data of the important tables in the business system 22. The important tables may be predetermined in association with corresponding tables for each application operating on the business system 22.

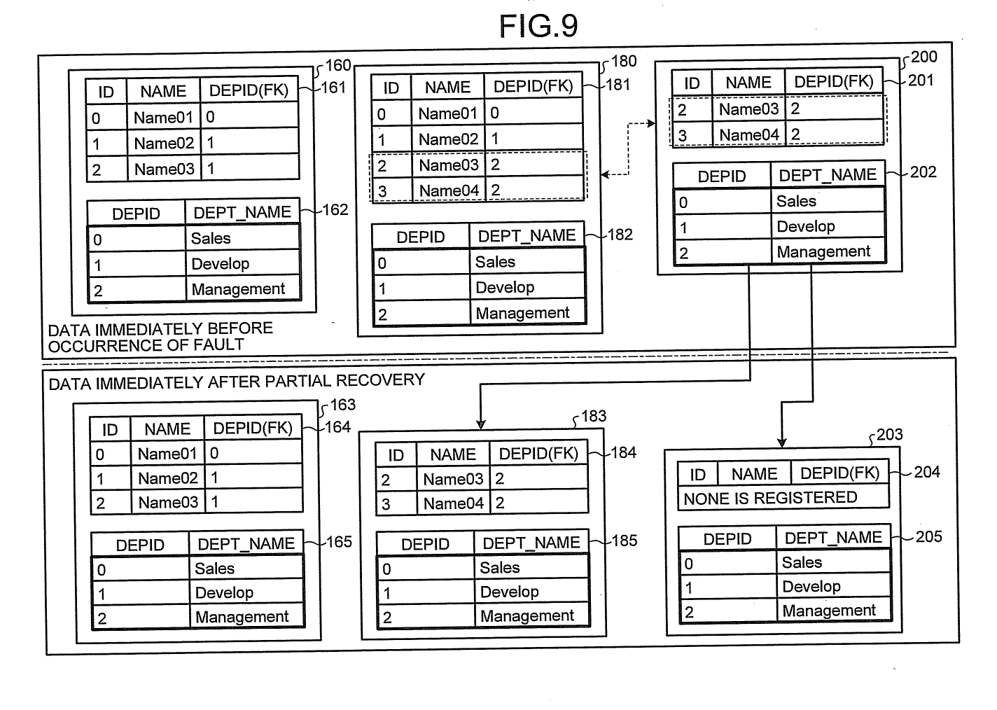

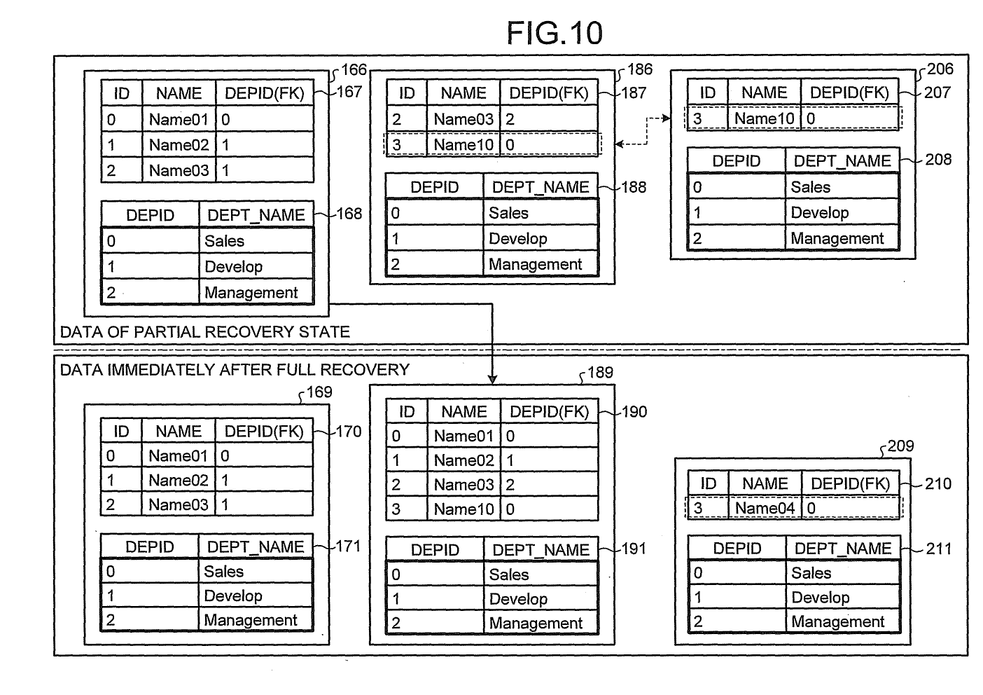

Data of the snapshot repository 12, the cache repository 13, and the data repository 23 of the present embodiment between the occurrence of the fault and the full recovery will be described with reference to FIGS. 9 and 10.

In the examples of FIGS. 9 and 10, a case where the data repository 23 stores therein a employee table including ID, NAME, and DEPID columns, and an department table including DEPID and DEPT_NAME columns will be described. The DEPID of the employee table is a primary key in the department table. That is, the DEPID of the employee table is an external key. The data of the department table are the above-described predetermined data that are stored in the cache repository 13.

FIG. 9 is a diagram for describing an example of data immediately after the partial recovery of the information processing system 100 of the third embodiment. Data 160 is data of the snapshot repository 12 immediately before the occurrence of the fault. The data 160 includes data 161 and data 162. The data 161 is data of the employee table immediately before the occurrence of the fault. The data 162 is data of the department table immediately before the occurrence of the fault.

Data 180 is data of the data repository 23 immediately before the occurrence of the fault. The data 180 includes data 181 and data 182. The data 181 is data of the employee table immediately before the occurrence of the fault. The data 182 is data of the department table immediately before the occurrence of the fault.

Data 200 is data of the cache repository 13 immediately before the occurrence of the fault. The data 200 includes data 201 and data 202. The data 201 is data of the employee table immediately before the occurrence of the fault. The data 202 is data of the department table immediately before the occurrence of the fault.

In the example of FIG. 9 illustrating the data immediately before the occurrence of the fault, data of (ID, NAME, DEPID)=(2, Name03, 2) of the data repository 23 is updated after the acquisition of the snapshot (DEPID is updated from 1 to 2). Data of (ID, NAME, DEPID)=(3, Name04, 2) is registered in the data repository 23 after the acquisition of the snapshot.

Therefore, the data 201 ((ID, NAME, DEPID)=(2, Name03, 2) and (3, Name04, 2)) are stored in the cache repository 13. The data 202 ((DEPID, DEPT_NAME)=(0, Sales), (1, Develop) and (2, Management)), which are all data stored in the department table, are stored, without regard to the presence or absence of the access to the data 182 of the data repository 23.

That is, the cache repository 13 of the present embodiment stores therein the data of the data repository 23 that has been accessed after the acquisition of the snapshot, and all data of the department table, which are predetermined data.

Data 163 is data of the snapshot repository 12 immediately after the partial recovery. The data 163 includes data 164 and data 165. The data 164 is data of the employee table immediately after the partial recovery. The data 165 is data of the department table immediately after the partial recovery.

Data 183 is data of the data repository 23 immediately after the partial recovery. The data 183 includes data 184 and data 185. The data 184 is data of the employee table immediately after the partial recovery. The data 185 is data of the department table immediately after the partial recovery.

Data 203 is data of the cache repository 13 immediately after the partial recovery. The data 203 includes data 204 and data 205. The data 204 is data of the employee table immediately after the partial recovery. The data 205 is data of the department table immediately after the partial recovery.

In the example of FIG. 9 illustrating the data immediately after the partial recovery, the data 184 ((ID, NAME, DEPID)=(2, Name03, 2) and (3, Name04, 2)) of the data repository 23 are recovered from the data 201 of the cache repository 13 immediately before the occurrence of the fault. The data 185 ((DEPID, DEPT_NAME)=(0, Sales), (1, Develop) and (2, Management)) of the data repository 23 are recovered from the data 202 of the cache repository 13 immediately before the occurrence of the fault.

After the partial recovery of the data repository 23, the data 201 of the cache repository 13 is deleted by the cache control unit 5. However, the data 202, that is, the data of the department table, which is the predetermined data, is not deleted by the cache control unit 5.

FIG. 10 is a diagram for describing an example of data immediately after the full recovery of the information processing system 100 of the third embodiment. Data 166 is data of the snapshot repository 12 of the partial recovery state. The data 166 includes data 167 and data 168. The data 167 is data of the employee table of the partial recovery state. The data 168 is data of the department table of the partial recovery state.

Data 186 is data of the data repository 23 of the partial recovery state. The data 186 includes data 187 and data 188. The data 187 is data of the employee table of the partial recovery state. The data 188 is data of the department table of the partial recovery state.

Data 206 is data of the cache repository 13 of the partial recovery state. The data 206 includes data 207 and data 208. The data 207 is data of the employee table of the partial recovery state. The data 208 is data of the department table of the partial recovery state.

In the example of FIG. 10 illustrating the data of the partial recovery state, data of (ID, NAME, DEPID)=(3, Name10, 0) of the data repository 23 is updated in the partial recovery state (NAME is updated from Name04 to Name10. Furthermore, DEPID is updated from 2 to 0). Therefore, data of (ID, NAME, DEPID)=(3, Name10, 0) is registered in the cache repository 13. The data 208 of the department table (the same as the data 202 of FIG. 9) is stored in the cache repository 13.

That is, the cache repository 13 of the present embodiment stores therein the data of the data repository 23 accessed in the partial recovery state, and the data 208 of the department table (the same as the data 202 of FIG. 9) is always stored without regard to the presence or absence of the access by the user.

Data 169 is data of the snapshot repository 12 immediately after the full recovery. The data 169 includes data 170 and data 171. The data 170 is data of the employee table immediately after the full recovery. The data 171 is data of the department table immediately after the full recovery.

Data 189 is data of the data repository 23 immediately after the full recovery. The data 189 includes data 190 and data 191. The data 190 is data of the employee table immediately after the full recovery. The data 191 is data of the department table immediately after the full recovery.

Data 209 is data of the cache repository 13 immediately after the full recovery. The data 209 includes data 210 and data 211. The data 210 is data of the employee table immediately after the full recovery. The data 211 is data of the department table immediately after the full recovery.

In the example of FIG. 10 illustrating the data immediately after the full recovery, (ID, NAME, DEPID)=(0, Name01, 0) and (1, Name02, 1) among the data 190 of the data repository 23 are restored using the data 167 of the snapshot repository 12. The data 191 of the data repository 23 is the same as the data 188.

Since (ID, NAME, DEPID)=(2, Name03, 2) is already restored from the data 201 of the cache repository 13 immediately before the occurrence of the fault (FIG. 9), the restoration unit 4 does not overwrite DEPID with 1.

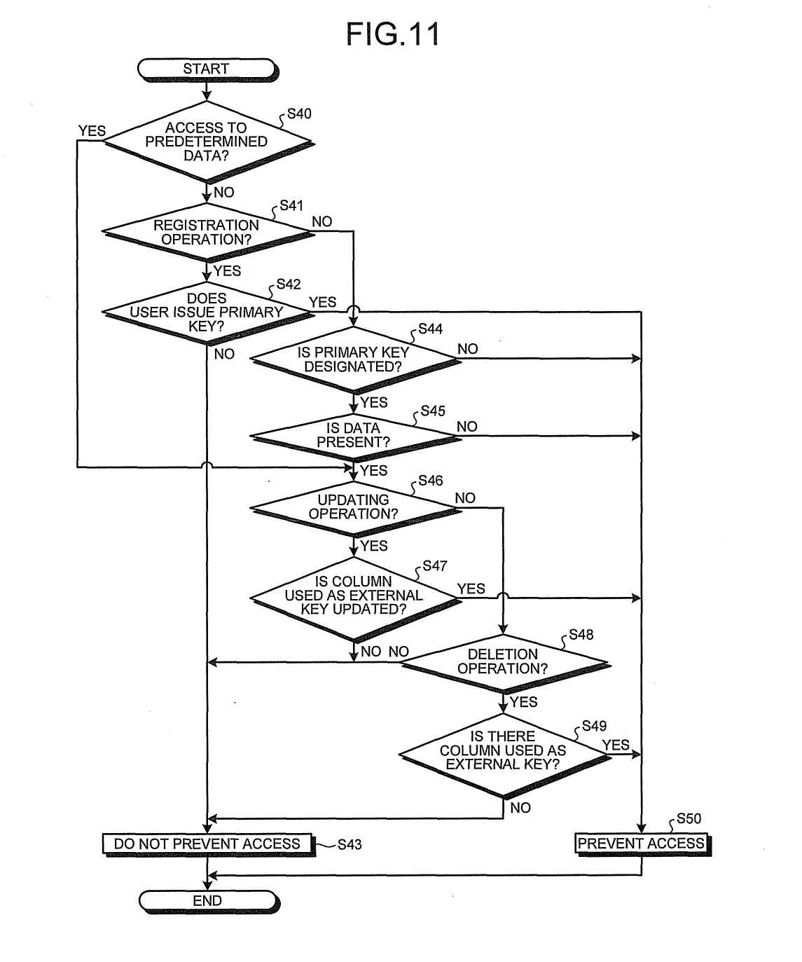

Next, the method for determining the access prevention in the partial recovery state according to the present embodiment will be described. FIG. 11 is a flow chart for describing an example of the method for determining the access prevention at the time of the partial recovery of the information processing system 100 of the third embodiment.

The access standby unit 6 determines whether the access from the business system 22 to the data repository 23 is an access to predetermined data (step S40). When the access is the access to the predetermined data (Yes in step S40), the process proceeds to step S46. When the access is not the access to the predetermined data (No in step S40), the process proceeds to step S41.

Since the access prevention determination processing from steps S41 to S50 is the same processes as steps S11 to S20 in the information processing system 100 according to the second embodiment, its description will be omitted.

In the above-described method for determining the access prevention, the operations for which an access to the RDB-type data repository 23 is not prevented in the partial recovery state are the following cases (1) to (8).

(1) The predetermined data is referenced. (2) In a case where data other than the predetermined data is registered in the RDB, the data is referenced by designating the primary key. (3) The column, which is not used as the external key of the predetermined data, is updated. (4) In a case where the column, which is not used as the external key of the data other than the predetermined data, is registered in the RDB, the column is updated by designating the primary key. (5) In a case where the predetermined data is stored in the table in which the column used as the external key is not present, the predetermined data is deleted. (6) In a case where the data other than the predetermined data is stored in the table in which the column used as the external key is not present, the data is deleted by designating the primary key. (7) The predetermined data is referenced (the predetermined data is registered in a predetermined table). (8) The data, which is not the predetermined data in which the appropriate primary key is issued by the business system 22, is registered.

According to the information processing system 100 of the present embodiment, even when the fault occurs in the virtual machine 21, the sustainability of the operation on the data of the RDB-type data repository 23 having recently been used by the user is guaranteed by the rapid partial recovery of the virtual machine 21 and the above-described method for determining the access prevention.

Furthermore, according to the information processing system 100 of the present embodiment, the virtual machine 21, even in the partial recovery state, can complete the operation in which the data integrity of the RDB-type data repository 23 is maintained, without causing the operation to wait.

Furthermore, the information processing system 100 of the present embodiment can expand the partial recovery range of the tenant system implemented by the virtual machine 21 by previously registering the predetermined data, without regard to the presence or absence of the access by the user.

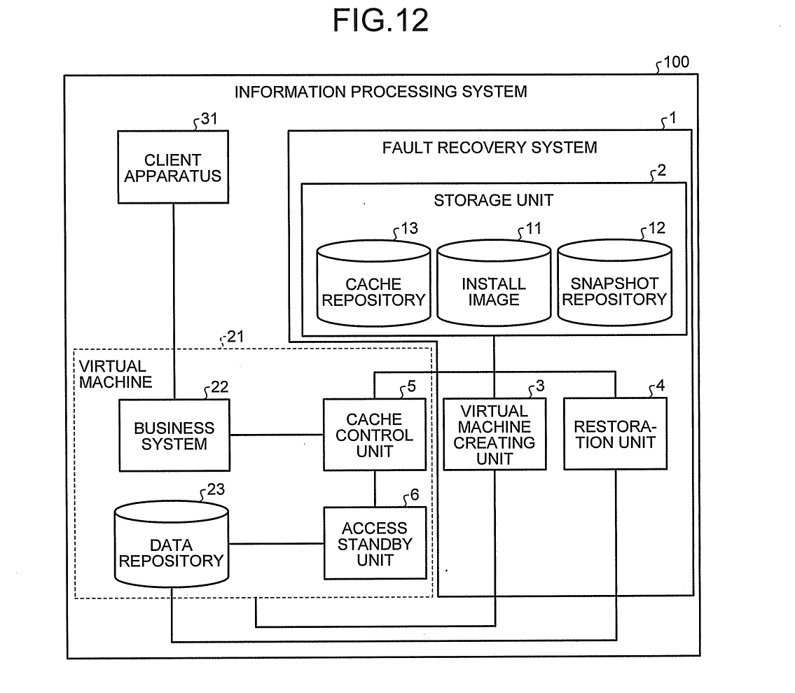

Next, modifications of the information processing systems 100 of the first, second and third embodiments will be described. FIG. 12 is a diagram for describing a first modification of the configurations of the information processing systems 100 of the first, second and third embodiments.

FIG. 12 illustrates an example of a case where the cache control unit 5 and the access standby unit 6 in the information processing systems 100 of the first, second and third embodiments are implemented on the virtual machine 21. As in the present modification, the cache control unit 5 and the access standby unit 6 may be implemented on the virtual machine 21.

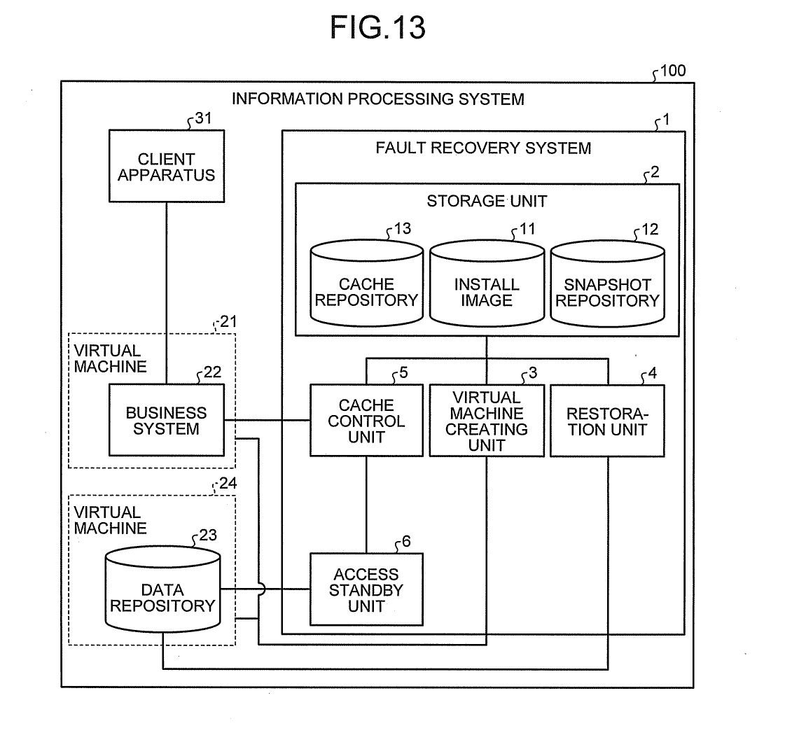

FIG. 13 is a diagram for describing a second modification of the configurations of the information processing systems 100 of the first, second and third embodiments. In FIG. 13, the business system 22 is implemented by the virtual machine 21. The data repository 23 is implemented by the virtual machine 24. As in the present modification, the tenant system, which is subjected to fault recovery by the fault recovery system 1, may implement the business system 22 and the data repository 23 by different virtual machines.

When the fault occurs in either of the business system 22 (virtual machine 21) and the data repository 23 (virtual machine 24), the fault recovery system 1 recovers only the virtual machine in which the fault occurs.

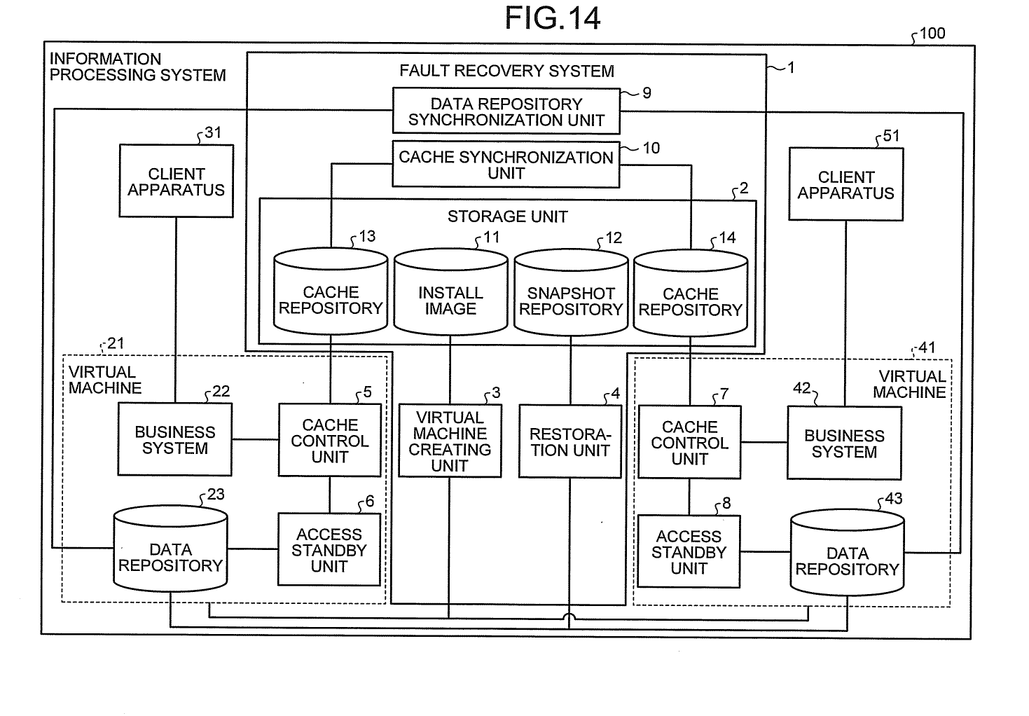

FIG. 14 is a diagram for describing a third modification of the configurations of the information processing systems 100 of the first, second and third embodiments. FIG. 14 illustrates an example of a case where the tenant systems (virtual machine 21 and virtual machine 41), which is subjected to fault recovery by the fault recovery system 1, are operated in parallel for load distribution and improvement in fault tolerance.

Alternatively, a client apparatus 31 accessing a business system 22 of the virtual machine 21, and a client apparatus 51 accessing a business system 42 of the virtual machine 41 may be the same apparatus.

The fault recovery system 1 of the third modification of FIG. 14 further includes a cache control unit 7, an access standby unit 8, a data repository synchronization unit 9, a cache synchronization unit 10, and a cache repository 14 in the configurations of the fault recovery systems 1 of the first, second and third embodiments.

The cache control unit 7 and the access standby unit 8 are present between the business system 42 and the data repository 43 and operate as proxy. That is, when accessing the business data of the data repository 43, the business system 42 performs the access through the cache control unit 7 and the access standby unit 8. Since the operations of the cache control unit 7 and the access standby unit 8 are identical to those of the cache control unit 5 and the access standby unit 6, their description will be omitted.

The cache repository 14 stores therein cache data representing a part of the business data of the data repository 43 of the virtual machine 41.

The data repository synchronization unit 9 synchronizes data so as to always maintain the states of the data of the data repository 23 and the data repository 43 in the same state.

In a case where the virtual machine 21 and the virtual machine 41 operate for the purpose of load distribution, when the data of the data repository of one of the virtual machines is changed, the data repository synchronization unit 9 also reflects the change to the data of the data repository of the other virtual machine. In a case where the virtual machine 21 and the virtual machine 41 operate for improving fault tolerance, the data repository synchronization unit 9 always monitors whether the data of the data repository 23 and the data repository 43 are consistent with each other.

Furthermore, in a case where one of the virtual machines is during the fault recovery (between the partial recovery and the full recovery), the data repository synchronization unit 9 reflects the data of the data repository, which has been changed in the other virtual machine being during the normal operation, to the data repository of the virtual machine being during the fault recovery.

Meanwhile, even though the data repository synchronization unit 9 reflects the data to the data repository of the virtual machine being during the fault recovery, the restoration unit 4 does not overwrite on the data already registered in the corresponding data repository. Therefore, the data integrity after the full recovery is not damaged.

The cache synchronization unit 10 synchronizes data so as to always maintain the states of the data of the cache repository 13 and the cache repository 14 in the same state. In a case where there is a change in one of the cache repositories, the cache synchronization unit 10 also reflects the corresponding change to the other cache repository.

In the third modification of FIG. 14, two virtual machines (virtual machine 21 and virtual machine 41) are subjected to the fault recovery. However, three or more virtual machines, which are subjected to the fault recovery, may be operated in parallel for the purpose of load distribution or the like. The case of operating three or more virtual machines in parallel is the same as the method for partially recovering the virtual machines. That is, cache repositories may be prepared for each virtual machine, and the virtual machines may be partially recovered.

The cache control unit 5 (7) and the access standby unit 6 (8) may be implemented on each virtual machine, or may share the cache control unit 5 and the access standby unit 6 implemented on the fault recovery system 1.

Furthermore, the virtual machine creating unit 3, the restoration unit 4, the data repository synchronization unit 9, and the cache synchronization unit 10 of the present embodiment may be implemented by software, or may be implemented by hardware such as IC or the like. Alternatively, they may be implemented by both of software and hardware.

According to the information processing system 100 of the third modification 3 of FIG. 14, the cache synchronization unit 10 synchronizes data of a plurality of cache repositories. Therefore, even when a plurality of virtual machines are operated in parallel, the virtual machines can be partially recovered, without causing data mismatching among the plurality of cache repositories.

According to the information processing system 100 of any one of the above-described embodiments, the virtual machine creating unit 3 creates a business system 22 (42) and an empty data repository 23 (43) in a newly created virtual machine 21 (24, 41), and the cache control unit 5 (7) partially recovers the data repository 23 (43) by using cache data. In this way, the user virtual machine 21 (24, 41) can be rapidly partially recovered.

Furthermore, according to the information processing system 100 of any one of the above-described embodiments, even when the fault occurs in the virtual machine 21 (24, 41), the sustainability of the operation on the data of the data repository 23 (43) having recently been used by the user is guaranteed by the rapid partial recovery and the above-described method for determining the access prevention.

Furthermore, according to the information processing system 100 of any one of the above-described embodiments, the user virtual machine 21 (24, 41), even in the partial recovery state, can complete the operation in which the data integrity of the data repository 23 (43) is maintained, without causing the operation to wait.

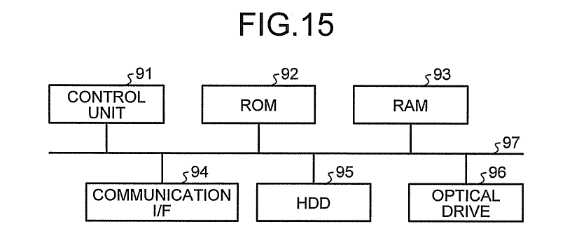

FIG. 15 is a diagram illustrating an example of a hardware configuration of the information processing apparatus on which the fault recovery systems 1 and the virtual machines 21 (24, 41) of the first, second and third embodiments operate.

The fault recovery system 1 of the above-described embodiment includes a control unit 91 such as a CPU or an IC, a main storage device such as a Read Only Memory (ROM) 92 or a Random Access Memory (RAM) 93, a communication I/F 94 for connection to a network, and an external storage device such as a Hard Disk Drive (HDD) 95 or an optical drive 96. The control unit 91, the ROM 92, the RAM 93, the communication I/F 94, the HDD 95, and the optical drive 96 are connected through a bus 97.

For example, the storage unit 2 of the above-described embodiment corresponds to the external storage device such as the Hard Disk Drive (HDD) 95 or the optical drive 96. The virtual machine creating unit 3, the restoration unit 4, the cache control unit 5 (7), the access standby unit 6 (8), the data repository synchronization unit 9, and the cache synchronization unit 10 of the above-described embodiment correspond to the control unit 91.

The virtual machine 21 (24, 41) and the fault recovery system 1 may be implemented by the same hardware, or may be implemented by different hardware.

A program executed in the fault recovery system 1 of the above-described embodiment is recorded in a computer-readable recording medium, such as a CD-ROM, a flexible disk (FD), a CD-R, a Digital Versatile Disk (DVD), in a file of an installable format or an executable format, and is provided as a computer program product.

The program executed in the fault recovery system 1 of the above-described embodiment may be stored on a computer connected to a network such as the Internet and be provided by download via the network. Furthermore, the program executed in the fault recovery system 1 of the above-described embodiment may be provided or distributed via the network such as the Internet.

The program of the fault recovery system 1 of the above-described embodiment may be provided while being embedded into the ROM 92 or the like.

The program executed in the fault recovery system 1 of the above-described embodiment is configured by a module including the above-described respective units (the virtual machine creating unit 3, the restoration unit 4, the cache control unit 5 (7), the access standby unit 6 (8), the data repository synchronization unit 9, and the cache synchronization unit 10). As the actual hardware, the CPU reads the program from the storage medium and executes the read program. Therefore, the respective units are loaded on the main storage device, so that the virtual machine creating unit 3, the restoration unit 4, the cache control unit 5 (7), the access standby unit 6 (8), the data repository synchronization unit 9, and the cache synchronization unit 10 are generated on the main storage device. Also, this will not apply to a case where part or all of the respective units are not implemented by the program but are implemented by hardware such as IC.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a storage unit configured to store therein install information of a user system implemented by a virtual machine, backup data of data of the user system, and cache data representing a part of the data of the user system;
a virtual machine creating unit configured to create the virtual machine using the install information;
a restoration unit configured to restore the data of the user system using the backup data;
a cache controller configured to copy a part of the data of the user system to the cache data and, in the event of the fault of the user system, partially recover the user system by restoring a part of the data of the user system from the cache data; and
an access standby unit configured to, after the partial recovery, prevent an access to the data of the user system, data integrity of which is not guaranteed, until the user system is fully recovered by restoring the data of the user system, which is not restored using the cache data, by using the backup data.

2. The system according to claim 1, wherein a part of the data of the user system is data that has been accessed from the user system.

3. The system according to claim 2, wherein, after the backup data is acquired, the cache controller copies the data, which has been accessed from the user system, to the cache data.

4. The system according to claim 2, wherein the cache controller deletes the cache data when the backup data is stored in the storage unit.

5. The system according to claim 1, wherein a part of the data of the user system is predetermined data.

6. The system according to claim 1, wherein, when preventing the access to the data of the user system, the access standby unit calculates a time taken for the full recovery, based on a data amount of the data of the user system to be restored, and when the time exceeds a predetermined threshold value, the access standby unit returns an error without preventing the access to the data of the user system.
